(19) United States
(12) Patent Application Publication
(10) Pub. No.: US 2009/0248799 A1
(43) Pub. Date: Oct. 1, 2009

(54) METHOD AND SERVER FOR USER IDENTIFIER UPDATE

(75) Inventor: Edoardo Gavita, Laval (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/058,961

(22) Filed: Mar. 31, 2008

(51) Int. Cl. G06F 7/06; G06F 15/16; G06F 17/30

(52) U.S. Cl. 709/204; 707/5; 707/E17.005

(57) ABSTRACT

A method and communication server for updating a user identifier, wherein the server detects that a user involved in a new communication has changed an old user identifier for a new identifier. The server also triggers a search for pre-defined groups containing the old user identifier and when determining that the user is part of one or more pre-defined groups, instructing an update of the one or more pre-defined groups with the new user identifier.

### TECHNICAL FIELD

The present invention relates to the area of user identification.

### BACKGROUND

The IP Multimedia Subsystem (IMS) is an architecture framework that supports delivery of Internet Protocol (IP) multimedia to mobile users. It was originally designed by the wireless standards body 3^{rd} Generation Partnership Project (3GGP), and is part of the vision for evolving mobile networks beyond GSM (General System for mobile Communications). In its original formulation, 3GPP R5 (Release 5) presented an approach to deliver Internet services over GPRS (General Packet Radio Service). This vision was later updated by 3GPP, 3GPP2, and TISPAN (Telecoms & Internet converged Services & Protocols for Advanced Networks), which is a standard body of the ETSI (European Telecommunications Standards Institute) by requiring support of networks other than GPRS, such as for example WLAN (Wireless Local Area Networks), CDMA2000 (Code Division Multiple Access 2000), and fixed line.

One of many Internet services supported by IMS is the Instant Messaging (IM), which is the real-time exchange of text messages through software application. Generally included in the IM technology is the ability to easily see the presence of contacts, i.e. to see whether a chosen friend, co-worker or buddy is online and connected through the selected service. IM differs from ordinary mail in the immediacy of the message exchange and also makes a continued exchange simpler than sending e-mails back and forth.

The IM exchange can take various forms and be for one-to-one communications or for group communications. One-to-one communication is when one user engages in a communication session with only one recipient. Group communications refer to more than two participants engaging in a communication session.

Each user has his/her own unique user identifier which can be changed by the operator or user at any time. When a user's user identifier is changed this means that any pre-defined group he/she is part of is no longer up to date. A pre-defined group is a group of users that have on one occasion or several occasions engaged in a group communication session with one another. The pre-defined group has a group identifier containing all the user's user identifiers.

Currently, in group communications, when the user wishes to change their own user identifier, the user has to manually initiate the change of his/her User Identifier in each and every group he/she belongs to. For this purpose, the user sends the update of the User Identifier to a server. The server receives the user initiated change of the user identifier and saves it. Thereafter the server sends a notification to group members stating that an individual's user identifier has been changed.

Although there is no prior art alike the present invention, the US Patent Publication number 2006/0206608 to Nalto et al. bears some relation with the field of the present current invention. This US publication describes a program which detects whether or not prescribed user information is included in the received user terminal information and a program which executes prescribed processing including at least one for registration, updates or transmission of user terminal information, based on user terminal information detected and user information stored as an information table. However, the teaching of this publication is limited to the detection of whether prescribed user information is included in user terminal information and stops short of the teachings of the present invention.

Reference is made to FIG. 1 (Prior Art), which is a flowchart diagram of a user initiating the change of their user identifier according to today's state of the art. The user changes his/her own user identifier (action 110) and verifies if he/she belongs to any pre-defined groups (action 120). If not, then no further action is required. If the user belongs to any pre-defined groups, then the user has to manually initiate the change of the user identifier (action 130). The updated user identifier is thereafter sent by the user, from his/her terminal, to the server (action 140). The server receives the user initiated user identifier (action 150) and optionally sends a notification to the group members to notify about the fact that the user identifier of an individual user has been updated. (action 60).

As it can be seen, the prior art method for changing users user information within pre-defined groups is cumbersome, as it requires the user to manually initiate the changes of the user identifier by sending the update of the change to the server. The server then sends the updated user identifier to all group members. This is not practical for the user since the latter may be a member of a large number of groups, and such individual updates may require significant manual updates, and the sending of multiple individual notification messages to be sent to each group member. There is therefore no known way for the automatic update of user's user information in pre-defined groups.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a flow diagram illustrating the steps of a user changing their user identifier according to a known prior art scheme;

FIG. 2a is an exemplary nodal operation and signal flow diagram of an IP Multimedia Subsystem (IMS) network containing a variant of the preferred embodiment of the present invention;

FIG. 2b is an exemplary nodal operation and signal flow diagram of an IP Multimedia Subsystem (IMS) network containing a further variant of the preferred embodiment of the present invention;

FIG. 3 is an exemplary diagram of a message structure according to a variant of the preferred embodiment of the present invention.

FIG. 4 is an exemplary flowchart diagram of a method for changing a user identifier according to a preferred embodiment of the present invention.

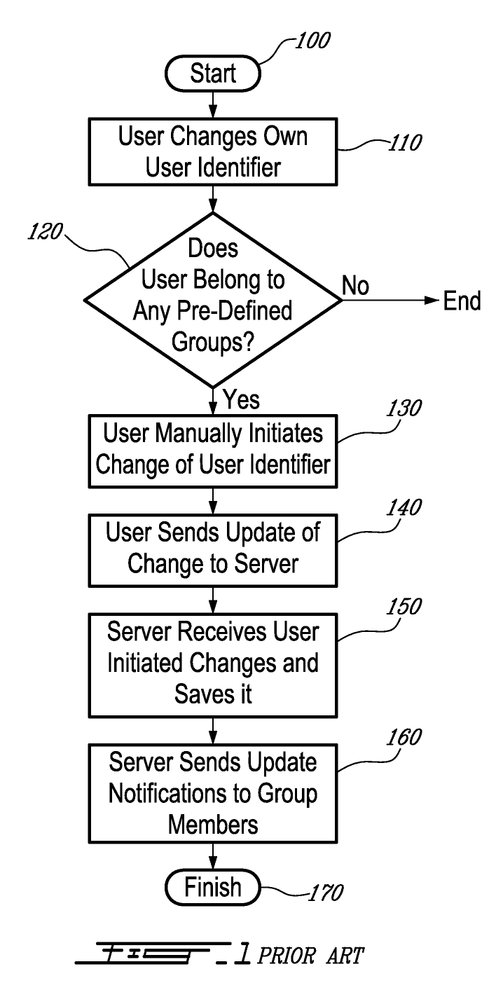

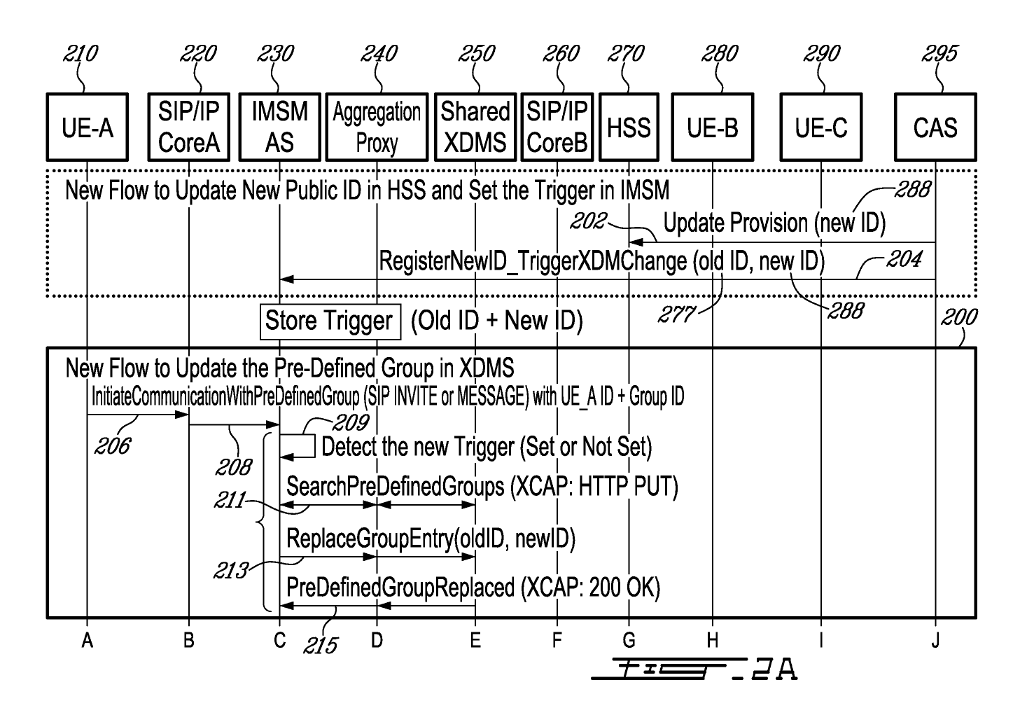

### DETAILED DESCRIPTION

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

According to the present invention and its related preferred embodiments, there is provided a method and a telecommunications server for assisting the user in the update of his/her user identifier in one or more pre-defined groups.

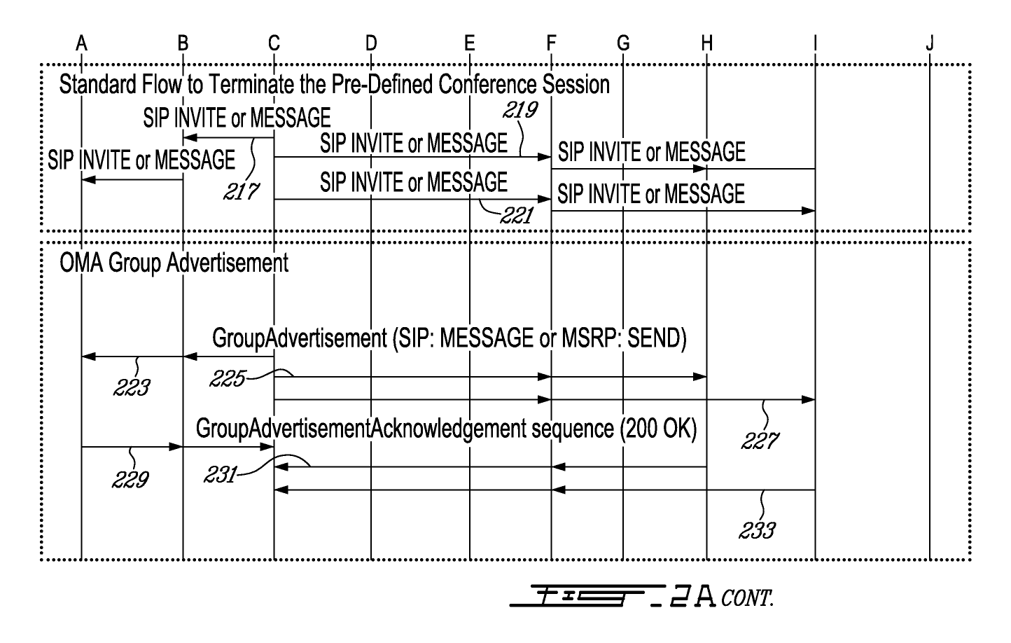

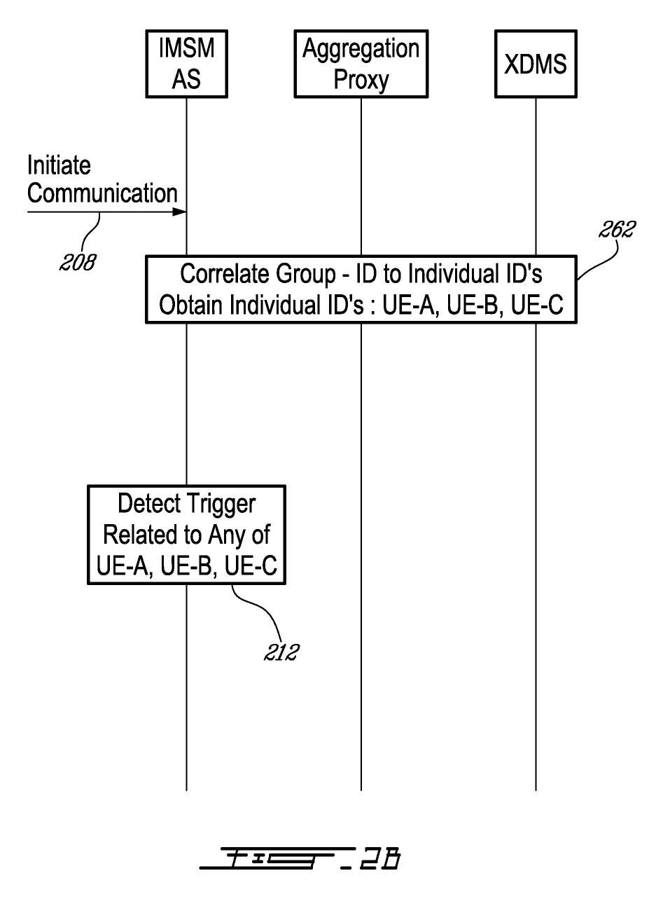

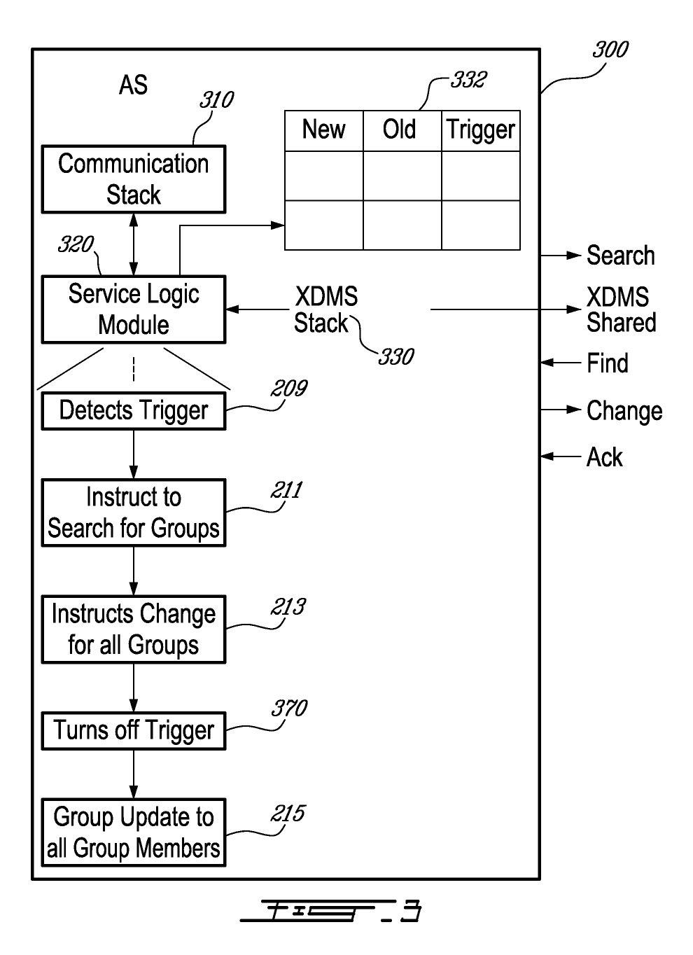

Reference is now made to FIG. 2a, which shows an exemplary nodal operation and signal flow diagram showing one of the preferred embodiments of the present invention. Shown in FIG. 2a is an Internet Protocol Multimedia Subsystem (IMS) network (200) where an old user identifier is being replaced with a new user identifier for a given user. It is to be understood that this is only an exemplary scenario, and that the invention can be advantageously implemented in various types of networks, such as for example email networks, non-IMS Instant messaging networks, etc.

Shown in FIG. 2a is an application server such as for example the IMS Messaging Application Server (IMSM AS) (230) that provides online delivery of messages, stores messages for offline users and handles functionality for deferred message delivery for offline users and later retrieval of these messages. The IMS network (200) further comprises a first Session Initiation Protocol/Internet (SIP/IP) Core A (220), which is an originating network including Call State Control Functions (CSCFs) needed to insure the messages exchange, and a second Session Initiation Protocol/Internet (SIP/IP) Core B (260) which is a terminating network, and which includes one or more Call State Control Functions (CSCFs) for the same purpose. The SIP/IP Core A (220) and SIP/IP Core B (260) route SIP signalling between the IM clients and the IM server (230), provide discovery and address resolution solutions, support SIP compression, perform authentication and authorization of IM Clients based on user's service profile and maintain the registration station and also provide charging information.

The Shared XML Data Management Server (XDMS) (250) is an XML Configuration Access Protocol (XCAP) Server that allows the storing and managing of XML documents containing user lists (including pre-defined group lists), group specific information and user profile information. The Aggregation Proxy (240) provides a single contact point for an XDM client to search data stored in XDM Servers. The Home Subscriber Service (HSS) (270) is a master database for network users. It is the entity containing the subscription-related information to support the network entities actually handling calls/sessions. The Customer Administration System (CAS) (295) may include a service center that administrates the network (200) and its subscribers and which sends customer and administrative orders to other network elements.

The exemplary scenario in FIG. 2a may start with the Customer Administration System (CAS) (295) updating an old user identifier (277) of user, UE-A (210) with a new user identifier (288) and sending the update to the Home Subscriber Server (HSS) (action 202). This may happen, for example, when a subscriber changes his/her identifier (277), e.g. one or more of his phone number, email address, or URI/URL. For example, the user John Doe, may desire to change his email address from john.d@operatorA.com to john.doe@operatorA.com. The new user identifier (288) together with a trigger (299) for storing the new identifier (288) and for replacing the old identifier (277) with the new identifier (288) is sent from the CAS (295) to the IMSM AS (230) (action 204). The receipt of the trigger and of the old and new identifiers instructs the IMSM AS (230) to update the user UE-A (210) pre-defined groups, if any, at the next communication that involves any of the groups the user is part of. For this purpose, the trigger (299) is stored in the IMSM AS (230), including, for example, both the old and new user identifiers (action 297). This trigger (299) tells the IMSM AS (230) to make the change to the IMS user's group lists when a call that involves the user having updated his identifier is received in the IMSM AS (230).

When, for example, the user UE-A (210) decides to start a group communication, for example a group Instant Message (IM), with UE-B (280) and UE-C (290) (action 206), the SIP/IP core (220) directs the IM request to the IMSM AS (230) (action 208). The IMSM AS (230) receives the IM messaging request (action 208) and verifies if it stores a trigger for the UE-A (action 209). If no trigger is detected for UE-A (210), then this means that the AS (230) does not need to do any group updates. If a trigger is detected, (action 209), which is assumed to be the case in the present exemplary scenario, then the IMSM AS 230 determines that a group update is needed because the user UE-A (210) changed his identifier. For this purpose, a search is conducted in the Shared XDMS (250) (action 211) for any pre-defined group list that contains the user's old identifier. If the search yields no hits then the call goes through with no changes. If the search yields one or more hits, the IMSM AS (230) makes the necessary changes to the determined group lists in the Shared XDMS (250) (action 213), by replacing the old user identifier 277 (e.g. john.d@operatorA.com) with the new user identifier 288 (e.g. john.doe@operatorA.com). The old pre-defined group the user was part of is updated with the new user identifier 288 and a confirmation of the update is sent back to IMSM AS (230) (action 215).

At the next step, the IMSM AS (230) handles the requested group communication by sending a SIP INVITE or SIP MESSAGE to UE-A (210) (action 217) and to UE-B (280) and UE-C (290) (action 219 and action 221).

Once the group is successfully updated, the IMSM AS (230) may optionally use an OMA Group Advertisement message to all group members, in order to notify them of the update. In this exemplary embodiment, the advertisement is sent to UE-A (210) (action 223), UE-B (280) (action 225) and UE-C (290) (action 227). A group advertisement acknowledgment sequence is then sent back from the user UE-A (210), UE-B (280) and UE-C (290) to the IMSM AS (230) (action 229, action 231, and action 233). The OMA Group Advertisement message may be a SIP message that is sent to each recipient in the group. The purpose of the message is to notify each recipient in the group that the pre-defined group list has been created or modified and that they are part of it. The message may contain the group name or address name and all the recipients in the group.

Reference is now made to FIG. 2b, which shows an exemplary nodal operation and signal flow diagram showing another possible variant of the preferred embodiments of the present invention. Shown in FIG. 2b is the same Internet Protocol Multimedia Subsystem (IMS) network (200) of FIG. 2a, but where an old user identifier is being replaced with a new user identifier for any one of the users of UE-A (210), UE-B (280), or UE-C (290). It is to be understood that this is only an exemplary scenario, and that the invention can be advantageously implemented in various types of networks, such as for example email networks, non-IMS Instant messaging networks, etc.

FIG. 2b follows the same steps of FIG. 2a until step 208 where the group communication is requested by UE-A (210). Thereafter, according to this variant of the invention, a need for an update of a pre-defined group can not only be determined for the initiator of the group communication, i.e. for UE-A (210) as in the previously described scenario, but also for any other participant to the group communication. For example, it is assumed in the present exemplary scenario that it is the user of UE-B (280) who updated his/her user identifier, from an old identifier to a new one, and thus that the user identifier update sequence of steps 202, 204, and 297 refers to UE-B (280) rather than to UE-A (210). To be able to detect the trigger referring to UE-B (280), the AS 230, at step 262, in cooperation with the XDMS server 250, correlates the group identifier received in message 208 to individual user identifiers of the group, to obtain individual IDs of all the intended participants to the group communication, i.e. of UE-A, UE-B and UE-C. Then, at step 212, the detection of a trigger related to any one of UE-A (210), UE-B (280) or UE-C (290) can take place. In the present scenario, it is detected that the trigger relates to UE-B (280), e.g. by associating the old user identifier of UE-B (280) stored by the AS (230) in the trigger with the UE-B's identifier obtained in action 262 and then the IMSM AS 230 determines that a group update is needed because the user UE-B (280) changed his identifier. Thereafter, the method continues with step 211 and onwards, in order to perform the group update in a manner similar to the one described hereinbefore for UE-A (210).

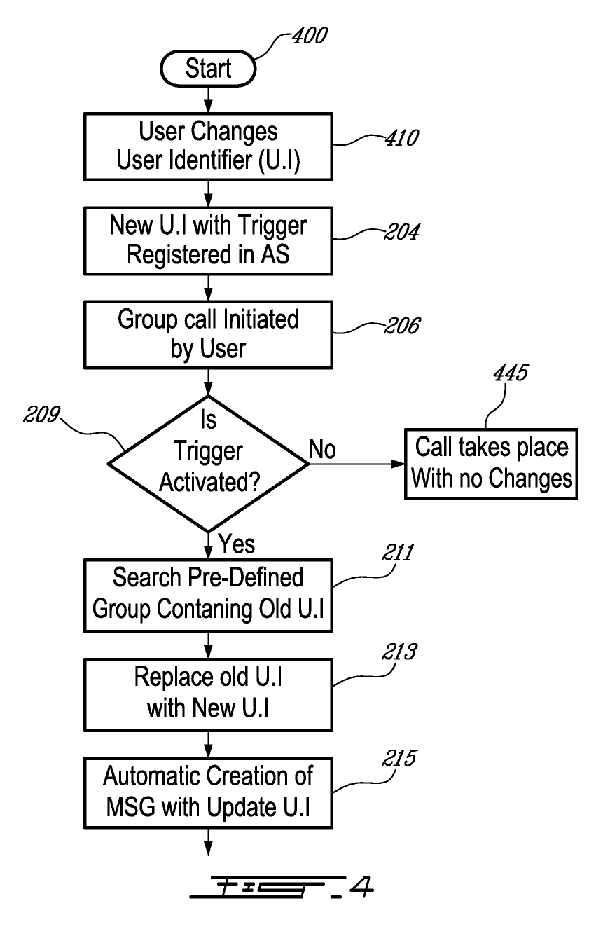

Reference is now made to FIG. 3, which shows an exemplary nodal operation and block diagram of an exemplary variant of the preferred embodiment of the invention. Shown in FIG. 3, is an application server (AS) such as for example an IMSM AS (300) where the present invention can be implemented, although it is to be understood that this is only an example, and that the invention can be advantageously implemented in various types of networks and nodes. This exemplary scenario describes how an IMS user's old user identifier is updated by a new user identifier and thereafter propagated from the server to the group members of the one or more pre-defined groups. The application server (300) contains a communication stack (310) that receives an indication that a new communication is being established, where such an indication may comprise a communication setup message, such as for example a SIP INVITE message (e.g. as shown in FIG. 2, action 208), a SIP MESSAGE message, a voice call setup message, an instant message of various types etc. The application server (300) further comprises a service logic module (320) that, upon receipt of the indication from the communication stack (310), detects the stored trigger (322) that a user involved in the new communication has changed an old user identifier for a new user identifier (e.g. as shown in FIG. 2 action 209). For this purpose, the communication stack (310) may relay the identifier of the initiator of the communication to the service logic module (320). The latter searches in the trigger storage for a trigger related to UE-A (210). Then, the service logic module (320), upon positive determination of the trigger (332), instructs the search (211) in the XDMS server (250) for pre-defined groups containing the old user identifier of the user who updated his/her identifier, e.g. UE-A (210). Alternatively, with reference being jointly made to the variant of the invention described in FIG. 2.b, the communication stack (310) may relay the identifiers all participants to the group communication to the service logic module (320) so that the later can detect triggers associated with any one of the participants. For this purpose, the service logic module (320) instructs the communications stack to first obtain the individual identifiers of the group members involved in the group communication, from the XDMS server (250). When this is completed as described in FIG. 2.a, the service logic searches in the trigger storage for a trigger related to any one of the group communication participants UE-A (210), UE-B (28), or UE-C (290). Then, the service logic module (320), upon positive determination of the trigger (332) related e.g. to UE-B (280), instructs the search (211) in the XDMS server (250) for pre-defined groups containing the old user identifier of the user who updated his/her identifier, e.g. UE-A (210) or UE-C (280).

When the update confirmation (215) is received back at the server (230), the service logic (320) turns off the trigger (action 370) and a message notification with the new user identifier is sent to all the group members (as shown in FIG. 2 action 215) by the communication stack (310).

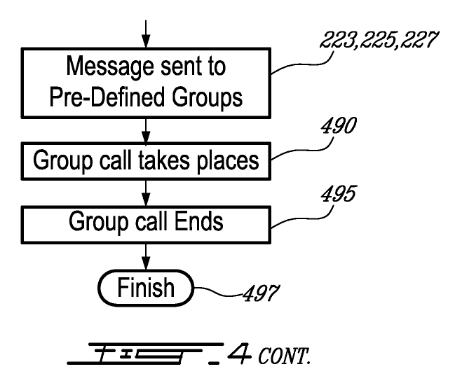

Reference is now made to FIG. 4, which shows an exemplary flow chart of one of the embodiments of the present invention. The user first changes his user identifier (action 410), replacing his old user identifier by a new user identifier. Upon such change, the old and the new user identifier with a trigger are registered in the application server (as shown in FIG. 2 action 204). The purpose of the trigger is to detect that a user that is involved in a new communication has changed an old user identifier for a new user identifier. At a later time, a group communication that involves the user takes place e.g. that is either initiated by the user or involves the user (as shown in FIG. 2 action (206). The service logic module detects if the trigger that involves a participant is activated (as shown in FIG. 2 action 209). If the trigger is not activated then the communication takes place without any changes (action 445).

If the trigger is activated, the service logic module (320) instructs the database storage to search for pre-defined groups containing the old user identifier (as shown in FIG. 2 action 211). Once the old user identifier is found it is replaced with the new user identifier (as shown in FIG. 2 action 213). A message with the updated User identifier is then automatically created (as shown in FIG. 2 action 215) and thereafter sent to the pre-defined groups (as shown in FIG. 2 actions 223, 225, 227). Thereafter the group call takes place (action 490) and consequently the group call ends (action 495).

Although the exemplary embodiments of the present invention have been mainly described with reference to message communications, such as the SIP MESSAGE message communication, it is to be understood by those skilled in the art that the application of the present invention is not limited to the transmission of SIP messages to a communication group. For example the message communication initiated by the UE-A (210) toward the UE-B (280) and UE-C (290) may be a voice group communication, a video conferencing communication, or any other type of communication, where upon detection of a trigger (340) old user identifiers are replaced with new user identifiers (360).

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for user identifier update, the method comprising the steps of:
a. receiving an indication of a new communication being established;
b. responsive to the indication, detecting that a user involved in the new communication has changed an old user identifier for a new user identifier;
c. triggering a search for pre-defined groups containing the old user identifier;
d. when determining that the user is part of one or more pre-defined groups, instructing an update of the one or more pre-defined groups with the new user identifier.

2. The method claimed of claim 1, wherein the receiving step takes place in an application server of a communication network.

3. The method claimed in claim 2, wherein the communication network is an IMS (IP Multimedia Subsystem) network.

4. The method claimed in claim 1, wherein the new communication is a one-to-one communication.

5. The method claimed in claim 1, wherein the new communication is a group communication.

6. The method claimed in claim 1, wherein the new communication comprises an IMS (IP Multimedia Subsystem) message.

7. The method claimed in claim 1, wherein the new communication is an IM (Instant Message) communication.

8. The method claimed in claim 1, wherein the new communication is an e-mail message communication.

9. The method claimed in claim 1, wherein the new communication is a SMS (Short Message Service) message communication.

10. The method claimed in claim 1, further comprising the steps of:
e. determining group members from the pre-defined group in order to perform step b.)

11. The method claimed in claim 10, further comprising the steps of:
instructing the sending of a group advertisement message to the one or more pre-defined groups for informing group members of the new user identifier.

12. A communication server comprising:
a communication stack receiving an indication of a new communication being established;
a service logic module, that responsive to said indication, detects that a user involved in the new communication has changed an old user identifier for a new user identifier, and triggers a search for pre-defined groups containing the old user identifier, and when determining that the user is part of one or more pre-defined groups, instructs an update of the one or more pre-defined groups with the new user identifier.

13. The communication server claimed in claim 12, further comprising:
a database storage for storing the old user identifier and the new user identifier.

14. The database storage claimed in claim 13, wherein the database storage receives the instruction to replace the old user identifier with the new user identifier.

15. The communication server claimed in claim 12, wherein the communication stack is SIP (Session Initiated Protocol) stack.

16. The communication server claimed in claim 12, wherein the new communication is a one-to-one communication.

17. The communication server claimed in claim 12, wherein the new communication is a group communication.

18. The communication server claimed in claim 12, wherein the new communication is an IMS (IP Multimedia Subsystem) communication.

19. The communication server claimed in claim 12, wherein the group communication is an IM (Instant Message) communication.

20. The communication server claimed in claim 12, wherein the group communication is an e-mail message communication.

21. The communication server claimed in claim 12, wherein the group communication is SMS (Short Message Service) message communication.

22. The communication server claimed in claim 12, wherein the communication stack determines the group members from the pre-defined groups.

23. The communication server claimed in claim 12, wherein the communication stack sends a group advertisement message to the one or more pre-defined groups informing them of the new user identifier.
